(19) United States
(12) Patent Application Publication
(10) Pub. No.: US 2015/0013664 A1
(43) Pub. Date: Jan. 15, 2015

(54) TABLE

(71) Applicant: Isaias Amby Riel, Lanai City, HI (US)

(72) Inventor: Isaias Amby Riel, Lanai City, HI (US)

(21) Appl. No.: 13/940,833

(22) Filed: Jul. 12, 2013

(51) Int. Cl. A47J 37/07

(52) U.S. Cl. CPC A47J 37/0781
USPC 126/506; 126/25 R

(57) ABSTRACT

A table including a support structure and a fire chamber configured to house a fire therein. The fire chamber includes an insulation device disposed about the fire chamber. The table includes a tabletop coupled to a top region of the fire chamber. The tabletop includes a cooking region in thermal communication with the fire chamber. The tabletop includes a storage compartment configured to store objects and a cover configured to cover the cooking region of the tabletop.

### BACKGROUND OF THE INVENTION

1. Field of the Invention

The present invention relates to tables, specifically to a table including a fireplace and grill.

2. Description of the Related Art

An outdoor fireplace is a place for building fires outside of the home. Similar in construction to an indoor fireplace, an outdoor fireplace is usually added to a stone, brick, or concrete patio. It often consists of a firebox and a chimney. As with indoor fireplaces, an outdoor fireplace requires cleaning and maintenance to keep it looking and working at its best. While an outdoor fireplace may not need to be cleaned as often, it will need to be cleaned regularly in order to keep it reasonably tidy and maintained and to remove ash build.

While indoor fireplaces are traditionally designed for heating, an outdoor fireplace is usually used for cooking. Many are designed to double as wood-fired ovens that allow homeowners to create meals such as pizzas and casseroles. Entire outdoor kitchens can evolve from the fireplace.

An outdoor fireplace can simply be a decorative element, which allows homeowners to enjoy a crackling fire while entertaining in the backyard. Some municipalities may prohibit purely decorative fireplaces

A barbecue grill is a device for cooking food by applying heat directly from below. There are several varieties of such grills, with most falling into one of two categories: gas-fueled and charcoal. There is a great debate over the merits of charcoal or gas for use as the cooking method between barbecue grillers.

Some improvements have been made in the field. Examples of references related to the present invention are described below in their own words, and the supporting teachings of each reference are incorporated by reference herein:

U.S. Pat. No. 8,020,546, issued to Bourgeois et al., discloses an outdoor grill of a teppanyaki style provides a grilling surface fueled with a propane/butane canister and burner arrangement. The grilling surface is surrounded by cool zones, one of which is in the form of easily removable tiles or plates. The pedestal and top are uniquely configured to provide multiple sitting areas with knee areas in between the pedestal and top periphery.

U.S. Pat. No. 5,168,796, issued to Porton et al., discloses a combination table and cooking grill comprising a substantially horizontal table top having a centrally disposed aperture formed therethrough with a table support surface formed about the periphery thereof mounted on the upper portion of a substantially vertical hollow pedestal, an inner grill housing to operatively house a heat source therein and a cooking grate disposed in operative alignment with the heat source and the centrally disposed aperture such that persons around the periphery of the substantially horizontal table top can cook on the cooking grate as well as place food, drinks, condiments and the like on the table support surface.

U.S. Pat. No. 4,840,128, issued to McFarlane et al., discloses a table (10) comprises a table top (11) having a centralized aperture into which a charcoal grill barbeque (12) is inset. Eating stations (13) are provided around the barbeque (12) on the table top (11) and a frame arrangement (21) fitted to barbeque (12) projects above the level of the table top (11) to prevent splashing thereof during use of the barbeque (12).

U.S. Pat. No. 4,788,905, issued to Von Kohorn, discloses a barbeque arrangement is provided which combines the cooking, eating and ventilating function of the system. The system contains an open fire grill surrounded by an unperforated griddle, both of which are surrounded by an eating counter. A fan is positioned below the cooking grill and griddle which forces the air upward between the eating counter and the griddle in the shape of an air curtain for removing hot smoking air from the cooking area and at the same time through ventilation provides a cooling effect for the users seated around the eating counter.

U.S. Pat. No. 4,635,614, issued to Segroves, discloses a picnic table having a table top extending over and between sturdy support opposite end legs with a pot cooker mounted on and extending through an opening in the table top at a location between the opposite end legs. The pot cooker structure has a rectangular box shaped metal shield and support container having top flanges that extend out over the top of a square frame of wood resting on the table top around the table top opening through which the box extends to below the table top. The box is provided with a side opening therein in the portion thereof that extends below the table top for passage of air therethrough and extension of a propane gas line therethrough from a propane gas bottle mounted with a chain connected to the bottom of the table top. A cylindrical gas burner element holder is also provided with a side opening for passing of air and the propane gas line therethrough that extends to a gas burner supported on a plate of a gas burner support suspended down in cylindrical gas burner element holder by flanged top extensions that overlap the top rim of the cylindrical holder. A serpentine cooking grill rests on the top rim of the cylindrical holder to support a pot with the pot bottom well down in the cooker box. A cover formed of wood is useable as a chopping block when not covering the top of the cooker box.

The inventions heretofore known suffer from a number of disadvantages which include not being friendly or socialable, not being interesting, not being pleasant to look at, not being soothing, not being relaxing, not being efficient in use, not being customizable, being too bulky or heavy, not being portable, not being able to be used in colder climates, being limited in application, being limited in use, being limited in interchangeability, being complex, being expensive, being limited in designs, and being limited in configurations.

What is needed is a table that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available tables. Accordingly, the present invention has been developed to provide a table providing an outdoor grill and fireplace.

According to one embodiment of the invention, there is a table that may include a support structure.

The table may include a fire chamber that may be disposed in an elevated position on the support structure and configured to house a fire therein. The fire chamber may include an open lateral face. The fire chamber may include an insulation device that may be disposed about the fire chamber. The support structure may include a lifting device configured to selectably elevate the fire chamber. The support structure may include a fan positioned and oriented to force air up through the fire chamber when in operation. The fire chamber may include a decorative cover configured to selectably cover the open lateral face of the fire chamber and a plurality of lights and hooks that may be disposed underneath the tabletop.

The table may include a tabletop that may be coupled to a top region of the fire chamber. The tabletop may include a cooking region in thermal communication with the fire chamber. The insulation device may be selected from the group of insulation devices consisting of: an insulating ring disposed about a top region of the fire chamber and configured to insulate the fire chamber from the tabletop, and a selectably removable insulation panel selectably coupleable to a lateral face of the fire chamber. The tabletop may include an insulated storage compartment that may be disposed therein and configured to store objects. The insulated storage compartment may be accessible through a top surface of the tabletop. The insulated storage compartment may include a drain configured to allow fluids to drain from the insulated storage compartment. The tabletop may include a storage compartment configured to store objects, that may be disposed about a top surface of the tabletop. The tabletop may include a cover configured to cover the cooking region of the tabletop.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a front perspective view of a table in use, according to one embodiment of the invention;

FIG. 2 is a front perspective view of a table, according to one embodiment of the invention;

FIG. 3 is an exploded front perspective view of a table, according to one embodiment of the invention;

FIG. 4 is a modular diagram of a table, according to one embodiment of the invention; and

FIG. 5 is a front perspective view of a plurality of modular tabletops of a table, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Many of the functional units described in this specification have been labeled as modules in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like. Modules may also be implemented in software for execution by various types of processors. An identified module of programmable or executable code may, for instance, comprise one or more physical or logical blocks of computer instructions which may, for instance, be organized as an object, procedure, or function.

Nevertheless, the executables of an identified module need not be physically located together, but may comprise disparate instructions stored in different locations which, when joined logically together, comprise the module and achieve the stated purpose for the module. Indeed, a module and/or a program of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The various system components and/or modules discussed herein may include one or more of the following: a host server, motherboard, network, chipset or other computing system including a processor for processing digital data; a memory device coupled to a processor for storing digital data; an input digitizer coupled to a processor for inputting digital data; an application program stored in a memory device and accessible by a processor for directing processing of digital data by the processor; a display device coupled to a processor and/or a memory device for displaying information derived from digital data processed by the processor; and a plurality of databases including memory device(s) and/or hardware/software driven logical data storage structure(s).

Various databases/memory devices described herein may include records associated with one or more functions, purposes, intended beneficiaries, benefits and the like of one or more modules as described herein or as one of ordinary skill in the art would recognize as appropriate and/or like data useful in the operation of the present invention.

As those skilled in the art will appreciate, any computers discussed herein may include an operating system, such as but not limited to: Andriod, iOS, BSD, IBM z/OS, Windows Phone, Windows CE, Palm OS, Windows Vista, NT, 95/98/2000, OS X, OS2; QNX, UNIX; GNU/Linux; Solaris; MacOS; and etc., as well as various conventional support software and drivers typically associated with computers. The computers may be in a home, industrial or business environment with access to a network. In an exemplary embodiment, access is through the Internet through a commercially-available web-browser software package, including but not limited to Internet Explorer, Google Chrome, Firefox, Opera, and Safari.

The present invention may be described herein in terms of functional block components, functions, options, screen shots, user interactions, optional selections, various processing steps, features, user interfaces, and the like. Each of such described herein may be one or more modules in exemplary embodiments of the invention even if not expressly named herein as being a module. It should be appreciated that such functional blocks and etc. may be realized by any number of hardware and/or software components configured to perform the specified functions. For example, the present invention may employ various integrated circuit components, e.g., memory elements, processing elements, logic elements, scripts, look-up tables, and the like, which may carry out a variety of functions under the control of one or more microprocessors or other control devices. Similarly, the software elements of the present invention may be implemented with any programming or scripting language such as but not limited to Eiffel, Haskell, C, C++, Java, Python, COBOL, Ruby, assembler, Groovy, PERL, Ada, Visual Basic, SQL Stored Procedures, AJAX, Bean Shell, and extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention may detect or prevent security issues with a client-side scripting language, such as JavaScript, VBScript or the like.

Additionally, many of the functional units and/or modules herein are described as being “in communication” with other functional units, third party devices/systems and/or modules. Being “in communication” refers to any manner and/or way in which functional units and/or modules, such as, but not limited to, computers, networks, mobile devices, program blocks, chips, scripts, drivers, instruction sets, databases and other types of hardware and/or software, may be in communication with each other. Some non-limiting examples include communicating, sending, and/or receiving data and metadata via: a wired network, a wireless network, shared access databases, circuitry, phone lines, internet backbones, transponders, network cards, busses, satellite signals, electric signals, electrical and magnetic fields and/or pulses, and/or so forth.

As used herein, the term “network” includes any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like. Moreover, although the invention may be implemented with TCP/IP communications protocols, the invention may also be implemented using other protocols, including but not limited to IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997), the contents of which are hereby incorporated by reference.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

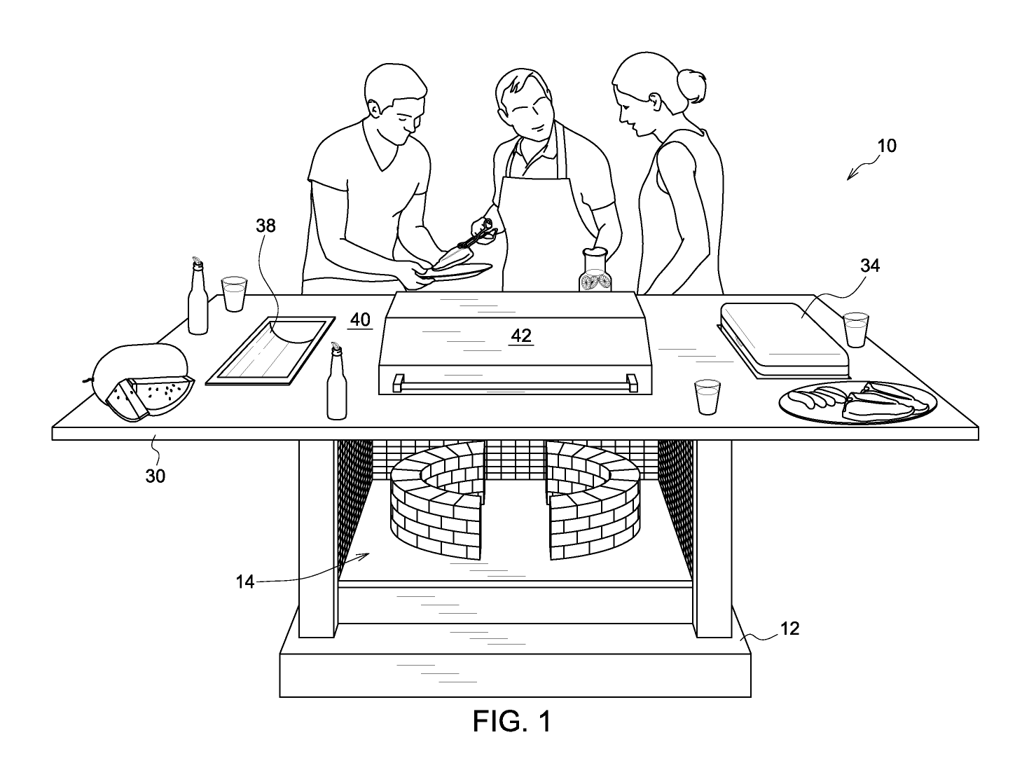

FIG. 1 is a front perspective view of a table in use, according to one embodiment of the invention. There is shown a table 10 including a support structure 12 and a tabletop 30. The illustrated table allows for a social cooking/eating experience wherein the participants may be comfortable and may be beneficially close to the cooking surface. Further, the illustrated table permits control over the heating of the cooking surface as well as the ambient surroundings, thus being suitable to localities of varying temperatures.

The illustrated table 10 is configured for outdoor dining and entertaining. The table 10 includes a support structure 12 for supporting the components of the table 10. The table 10 includes a fire chamber 14 disposed in an elevated position on the support structure 12 and configured to house a fire therein. The table 10 includes a tabletop 30 coupled to a top region of the fire chamber 14. The tabletop 30 includes a cooking region in thermal communication with the fire chamber 14, wherein the cooking region is directly above the fire chamber 14. The tabletop 30 includes an insulated storage compartment 34 disposed therein and configured to store objects. The insulated storage compartment 34 is accessible through a top surface 40 of the tabletop 30. The tabletop 30 includes a storage compartment 38 configured to store objects, disposed about a top surface 40 of the tabletop 30. The tabletop 30 includes a cover 42 configured to cover the cooking region of the tabletop 30.

According to one embodiment of the invention, there is a see-through fireplace disposed underneath a picnic table having a grill, in the middle of the table. The table includes two storage ice trays inset into the table and having top surfaces that may be at the same level as the tabletop. The storage ice trays are disposed near the grill and are insulated. The ice trays may include runoff channels that channel fluid, like a rain gutter system, down the sides of the table. The fireplace is adjustable so the height may be adjusted to lift the fireplace and the heating source higher or lower, closer or away from the grill. The table includes a fan disposed below the fireplace, helping channel the smoke directly upward.

According to one embodiment of the invention, there is a table including removable side covers to cover a fireplace. The table includes modular tabletops allowing the user to replace the top of table with different configuration. The table includes decorative elements that interact with the light from the fireplace on the sides thereof. The table includes lights underneath the table that point down. The table includes different types of insulation shields to protect from too much heat under the table including adjustable insulation shields. The table includes a protective gap/layer between the fireplace and the tabletop. The table includes a base around the fireplace that is elevated and helps protect the user from placing feet too close to the fire. The table includes metal mesh around three sides of the grill to keep users from placing hands in or onto the grill. The table includes a removable cover over the grill.

Advantageously, the illustrated table operates simultaneously as a fireplace, warming the surroundings, and a grill. It provides the benefits of both structures to those operating and surrounding the structure and creates a location about which the benefits of both structures may be simultaneously experienced. The illustrated table may also be easily disassembled and stored and/or may be reconfigured in a modular manner, such as but not limited to replacing a table-top structure for another having varying configurations, such as but not limited to differently sized and/or shaped cavities for storing food and other materials.

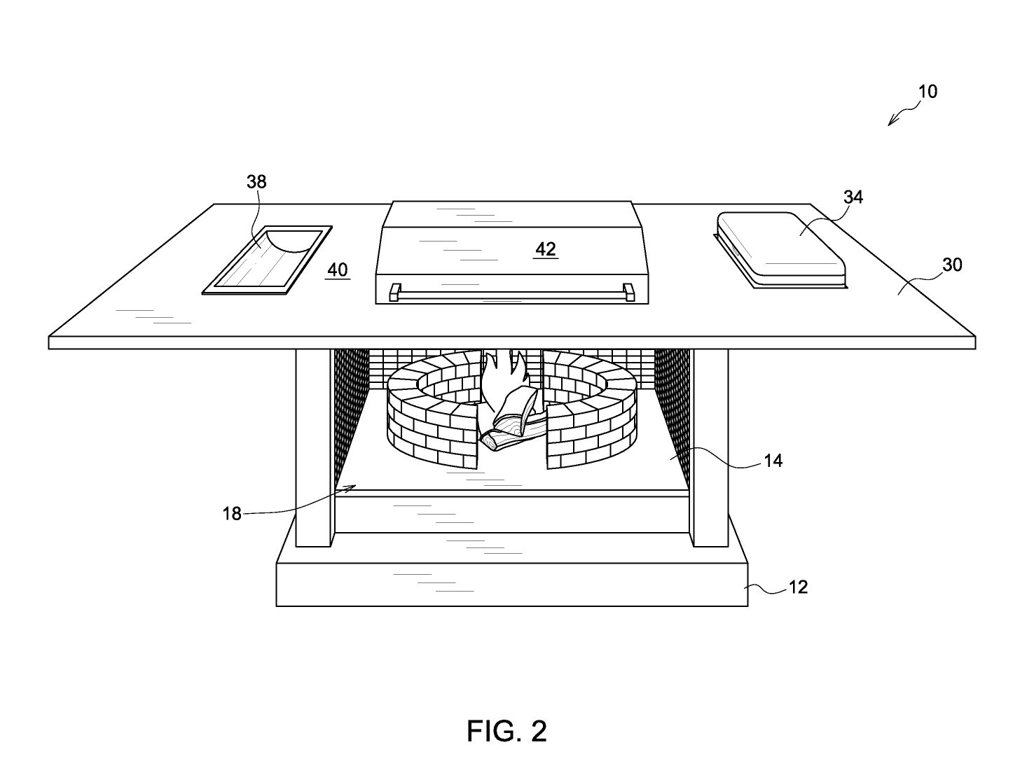

FIG. 2 is a front perspective view of a table, according to one embodiment of the invention. There is shown a table 10 including a support structure 12 and a tabletop 30.

The illustrated table 10 is configured for outdoor dining and entertaining. The table 10 includes a support structure for supporting a fire chamber 14 and a tabletop 30 thereon. The fire chamber 14 is disposed in an elevated position on the support structure, thereby allowing users to place their feet near the table 10 without placing them into the fire chamber 14. The fire chamber 14 is configured to house a fire therein. The fire chamber 14 includes an open lateral face 18, wherein the fire is fully exposed through the open lateral face 18. The tabletop 30 is coupled to a top region of the fire chamber 14. The tabletop 30 includes a cooking region in thermal communication with the fire chamber 14, wherein the cooking region is disposed directly above the fire chamber 14. The tabletop 30 includes an insulated storage compartment 34 configured to disposed therein and configured to store objects. The insulated storage compartment 34 is selectably removable from the table and separately stored or used. The tabletop 30 includes a storage compartment 38 configured to store objects disposed on a top surface 40 of the tabletop 30, wherein the storage compartment 38 is selectably removable for cleaning and separate use. The tabletop 30 includes a cover 42 configured to cover the cooking region of the tabletop 30 during use or storage.

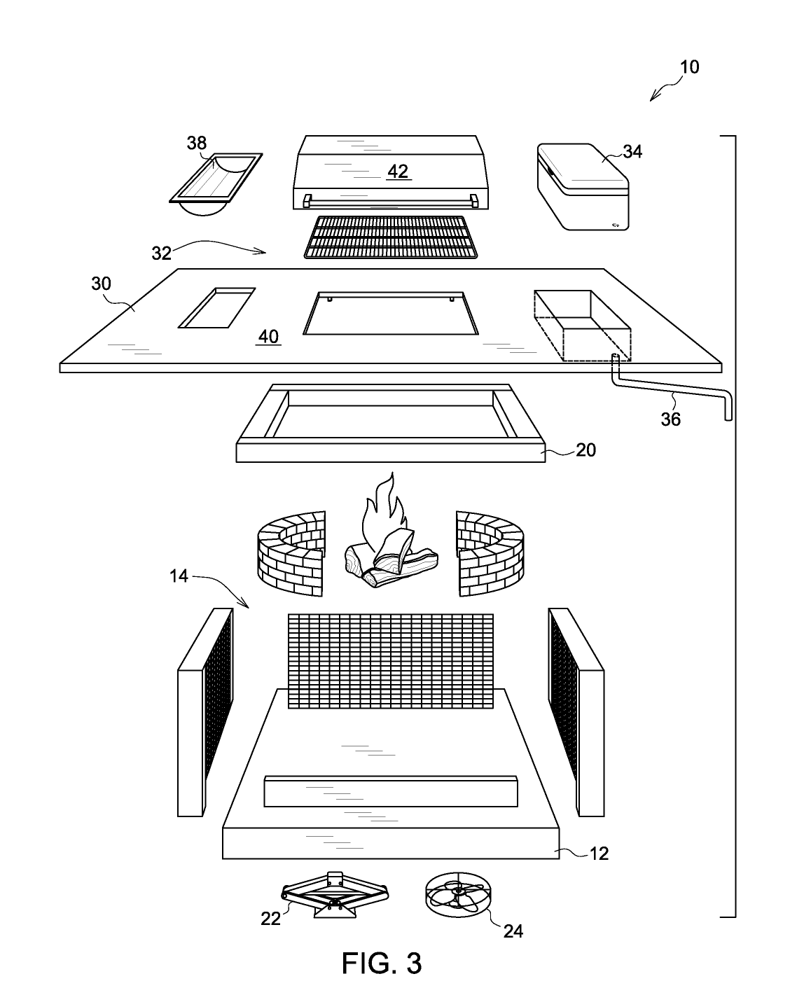

FIG. 3 is an exploded front perspective view of a table, according to one embodiment of the invention. There is shown a table 10 including a support structure 12 and a tabletop 30.

The illustrated table 10 includes a support structure 12 supporting components and modules of the table 10. The table 10 includes a fire chamber 14 disposed in an elevated position on the support structure 12 and configured to house a fire therein. The fire chamber 14 includes an open lateral face. The fire chamber 14 includes an insulation device 20 disposed about the fire chamber 14 and configured to insulate the tabletop 30 from the fire from the fire chamber 14. The support structure 12 includes a lifting device 22 configured to selectably elevate the fire chamber, up or down, to change the vertical position of the fire chamber 14. The support structure 12 includes a fan 24 positioned and oriented to force air up through the fire chamber 14 when in operation.

The table 10 includes a tabletop 30 coupled to a top region of the fire chamber 14. The tabletop 30 includes a cooking region 32 in thermal communication with the fire chamber 14, wherein the cooking region 32 is disposed directly above the fire chamber 14. The insulation device 20 is selected from the group of insulation devices consisting of: an insulating ring 20 disposed about a top region of the fire chamber 14 and configured to insulate the fire chamber 14 from the tabletop 30, and a selectably removable insulation panel selectably coupleable to a lateral face of the fire chamber.

The tabletop 30 includes an insulated storage compartment 34 disposed within the tabletop 30 and configured to store objects. The insulated storage compartment 34 is accessible through a top surface 40 of the tabletop 30. The insulated storage compartment 34 includes a drain 36 configured to allow fluids to drain from the insulated storage compartment 34. There may be a valve that may be in fluid communication with the drain that may permit selectable draining of the compartment by actuation of the valve. The tabletop 30 includes a storage compartment 38 configured to store objects, disposed about a top surface 40 of the tabletop 30. The tabletop 30 includes a cover 42 configured to cover the cooking region 32 of the tabletop 30.

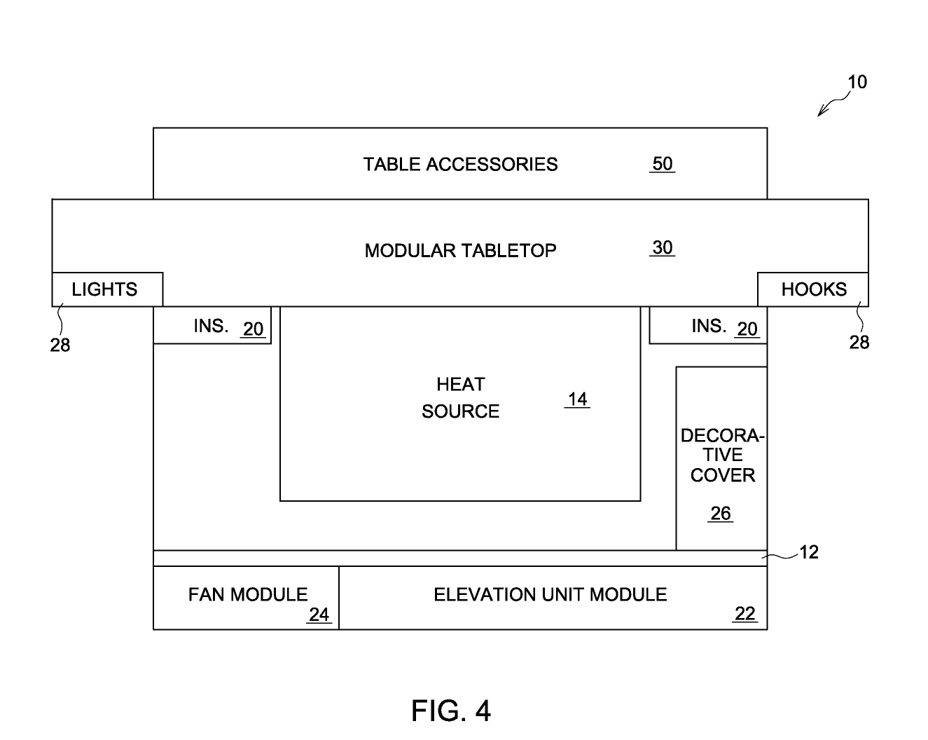

FIG. 4 is a modular diagram of a table, according to one embodiment of the invention. There is shown a table 10 including a support structure 12 and a modular tabletop 30.

The illustrated table is configured for outdoor cooking and entertaining. The table 10 includes a heat source 14 disposed within a support structure of the table 10. The heat source 14 is disposed within a fire chamber disposed in an elevated position on the support structure and configured to house the heat source 14 therein. The table 10 an insulation device 20 disposed about the heat source 14. The insulation device may be selected from the group of insulation devices consisting of: an insulating ring disposed about a top region of the heat source and configured to insulate the heat source from the tabletop, and a selectably removable insulation panel selectably coupleable to a lateral face of the heat source.

The table 10 includes an elevation unit module 22 configured to selectably elevate the heat source 14. The table 10 includes a fan module 24 positioned and oriented to force air up through the heat source when in operation. The fan module 24 includes a fan for blowing air and controls for operating the fan. Such controls may be as simple as an on/off switch coupled to a power source or may be more complicated, including but not limited to computerize controls, such as those found in heating/air conditioning units, wireless controls, communication with one or more networks and/or smartphone applications that may be used to control the fan. Further, the fan controls may include one or more scripts and/or automated control programs that may be in communication with one or more sensor devices as part of the fan that may be disposed within the table, including but not limited to heat sensors, oxygen sensors, CO sensors, CO2 sensors, smoke sensors, light sensors, and the like and combinations thereof. The table 10 includes a decorative cover 26 configured to selectably cover an open lateral face of the heat source 14. The table 10 includes a plurality of lights and hooks 28 disposed underneath a modular tabletop 30.

The table 10 includes a modular tabletop 30 coupled to a top region of the heat source 14. The modular tabletop 30 includes a cooking region in thermal communication with the heat source 14. The table 10 includes a plurality of table accessories 50, such as, but not limited to: an insulated storage compartment or a storage compartment, both configured to store objects and be disposed about a top surface of the modular tabletop 30.

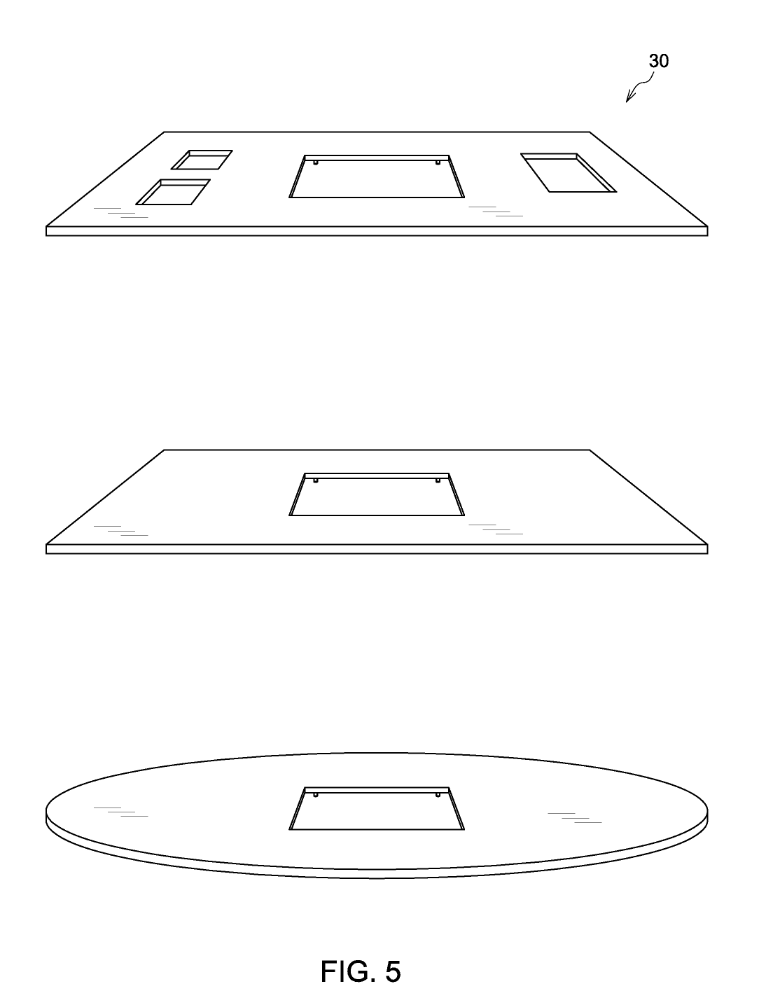

FIG. 5 is a front perspective view of a plurality of modular tabletops of a table, according to one embodiment of the invention. There is shown a plurality of various configurations for a tabletop 30.

The illustrated tabletops 30 are configured to be selectably coupleable to a top region of a fire chamber of a table. The tabletops 30 may vary in size, shape, configuration, design, layout, etc. and still performs its intended function. The tabletops 30 may include a plurality of apertures sized and shaped to receive a storage compartment or other tabletop accessory configured to assist in outdoor cooking or entertaining. Various tabletops may also include varying structures, mounting points, ports, channels, drains, water/gas/oil/condiment hookup structures, cutting surfaces, cooking surfaces, embedded electronic devices, coupling structures, canopies, lids, covers, shields, blinds, and the like and combinations thereof. There may be a kit including a plurality of interchangeable tabletops for use with a table as described herein.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the figures illustrate particular embodiments, various embodiments may be different, including but not limited to: having removable side covers to cover the fireplace region of the table, not including a fan, wherein the table assembly is a single structure that cannot be easily disassembled, wherein there are decorative elements that reflect/color/diffuse/etc. light from the fireplace that are disposed in regions of the table assembly that are in line of sight of the users, lights under the table that are directed in a downward orientation to provide lighting under the table, sets of heat shields (side covers) having varying performance characteristics and/or decorative elements such that the side covers may be interchangeable, a metal mesh disposed about the grill to keep people from putting their hands therein, and/or a removable cover for the grill.

Additionally, although the figures illustrate people disposed about a backside of the table in order to better show the table, it is understood that people may gather about all sides of the table.

Finally, it is envisioned that the components of the device may be constructed of a variety of materials, including but not limited to metals, ceramics, stone, minerals, plastics, rubbers, polymers, wood, fibers, composites, and the like and combinations thereof.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A table, comprising:
a) a support structure;
b) a fire chamber disposed in an elevated position on the support structure and configured to house a fire therein; wherein the fire chamber includes an open lateral face; and
c) a tabletop coupled to a top region of the fire chamber; wherein the tabletop includes a cooking region in thermal communication with the fire chamber.

2. The table of claim 1, wherein the support structure includes a lifting device configured to selectably elevate the fire chamber.

3. The table of claim 1, wherein the support structure includes a fan positioned and oriented to force air up through the fire chamber when in operation.

4. The table of claim 1, wherein the fire chamber includes an insulation device disposed about the fire chamber, the insulation device selection from the group of insulation devices consisting of an insulating ring disposed about a top region of the fire chamber and configured to insulate the fire chamber from the tabletop, and a selectably removable insulation panel selectably coupleable to a lateral face of the fire chamber.

5. The table of claim 1, wherein the fire chamber includes a decorative cover configured to selectably cover the open lateral face of the fire chamber and a plurality of lights and hooks disposed underneath the tabletop.

6. The table of claim 1, wherein the tabletop includes an insulated storage compartment disposed therein configured to store objects, the insulated storage compartment being accessible through a top surface of the tabletop.

7. The table of claim 6, wherein the insulated storage compartment includes a drain configured to allow fluids to drain from the insulated storage compartment.

8. The table of claim 1, wherein the tabletop includes a storage compartment configured to store objects, disposed about a top surface of the tabletop.

9. The table of claim 1, wherein the tabletop includes a cover configured to cover the cooking region of the tabletop.

10. A table, comprising:
a) a support structure;
b) a fire chamber disposed in an elevated position on the support structure and configured to house a fire therein; wherein the fire chamber includes an open lateral face; wherein the fire chamber includes an insulation device disposed about the fire chamber; and
c) a tabletop coupled to a top region of the fire chamber; wherein the tabletop includes a cooking region in thermal communication with the fire chamber.

11. The table of claim 10, wherein the support structure includes a lifting device configured to selectably elevate the fire chamber.

12. The table of claim 11, wherein the support structure includes a fan positioned and oriented to force air up through the fire chamber when in operation.

13. The table of claim 12, wherein the insulation device selection from the group of insulation devices consisting of an insulating ring disposed about a top region of the fire chamber and configured to insulate the fire chamber from the tabletop, and a selectably removable insulation panel selectably coupleable to a lateral face of the fire chamber.

14. The table of claim 13, wherein the fire chamber includes a decorative cover configured to selectably cover the open lateral face of the fire chamber and a plurality of lights and hooks disposed underneath the tabletop.

15. The table of claim 14, wherein the tabletop includes an insulated storage compartment disposed therein configured to store objects, the insulated storage compartment being accessible through a top surface of the tabletop.

16. The table of claim 15, wherein the insulated storage compartment includes a drain configured to allow fluids to drain from the insulated storage compartment.

17. The table of claim 16, wherein the tabletop includes a storage compartment configured to store objects, disposed about a top surface of the tabletop.

18. The table of claim 17, wherein the tabletop includes a cover configured to cover the cooking region of the tabletop.

19. A table, comprising:
a) a support structure;
b) a fire chamber disposed in an elevated position on the support structure and configured to house a fire therein; wherein the fire chamber includes an open lateral face; wherein the fire chamber includes an insulation device disposed about the fire chamber; wherein the support structure includes a lifting device configured to selectably elevate the fire chamber; wherein the support structure includes a fan positioned and oriented to force air up through the fire chamber when in operation; and
c) a tabletop coupled to a top region of the fire chamber; wherein the tabletop includes a cooking region in thermal communication with the fire chamber; wherein the fire chamber includes a decorative cover configured to selectably cover the open lateral face of the fire chamber and a plurality of lights and hooks disposed underneath the tabletop; wherein the insulation device selection from the group of insulation devices consisting of an insulating ring disposed about a top region of the fire chamber and configured to insulate the fire chamber from the tabletop, and a selectably removable insulation panel selectably coupleable to a lateral face of the fire chamber; wherein the tabletop includes an insulated storage compartment disposed therein configured to store objects, the insulated storage compartment being accessible through a top surface of the tabletop; wherein the insulated storage compartment includes a drain configured to allow fluids to drain from the insulated storage compartment; wherein the tabletop includes a storage compartment configured to store objects, disposed about a top surface of the tabletop; wherein the tabletop includes a cover configured to cover the cooking region of the tabletop.
